(19) United States
(12) Patent Application Publication
(10) Pub. No.: US 2024/0228916 A1
(43) Pub. Date: Jul. 11, 2024

(54) SPRAY-DRIED PARTICULATE COMPOSITION

(71) Applicant: The Procter & Gamble Company, Cincinnati, OH (US)

(72) Inventors: Dan XU, Beijing (CN); Fan LIU, Beijing (CN); Xiaoyu ZHAO, Beijing (CN); Jie LEI, Beijing (CN)

(21) Appl. No.: 18/537,376

(22) Filed: Dec. 12, 2023

(30) Foreign Application Priority Data
Dec. 30, 2022 (WO) PCT/CN2022/144037

(51) Int. Cl. C11D 17/06; C11D 3/34; C11D 3/37

(52) U.S. Cl. CPC C11D 17/06; C11D 3/3418; C11D 3/3707; C11D 3/3761

(57) ABSTRACT

The present invention relates to a spray-dried particulate composition comprising a carboxyl group-containing polymer, a linear alkyl benzene sulphonate (LAS) and a soap powder.

### FIELD OF THE INVENTION

The present invention relates to a spray-dried particulate composition comprising a carboxyl group-containing polymer, a linear alkyl benzene sulphonate (LAS) and a soap powder.

### BACKGROUND OF THE INVENTION

LAS which can provide a good cleaning performance has been used in detergent products for many years. Recently, due to being environment-friendly, fatty acids or salts thereof (hereinafter “soaps”) become more and more important in cleaning products, especially in powder or granular detergent products. As such, detergent products containing both LAS and soaps are desirable for consumers. In powder detergent products containing both LAS and soaps, a structurant is required to ensure the formation of particles. Some polymers such as acrylic acid/maleic acid copolymer are used as the structurant to provide a powder product without significant clumping and/or caking. However, the presence of such polymer such as acrylic acid/maleic acid copolymer may lead to increased viscosity of the slurry for making powders. This increased viscosity would result in several process difficulties during spray drying, e.g. difficulties or higher cost for mixing/pumping, undesired air entrapment during mixing and reduced drying rate.

Accordingly, there is a need to provide laundry detergent powder products containing LAS and soap that exhibit an appropriate viscosity of slurry during the spray drying.

The inventors have surprisingly found that a spray-dried particulate composition comprising a carboxyl group-containing polymer, a linear alkyl benzene sulphonate (LAS) and a soap powder can exhibit an appropriate viscosity of slurry during the spray drying. Furthermore, the inventors have surprisingly found that a spray-dried particulate composition comprising a carboxyl group-containing polymer, a linear alkyl benzene sulphonate (LAS) and a soap powder can provide an improved converting efficiency of soap in plant-scale.

### SUMMARY OF THE INVENTION

In one aspect, the present invention relates to a spray-dried particulate composition comprising:
(a) from 0.1 wt % to 3 wt %, by weight of the composition, of a carboxyl group-containing polymer comprising:
   (i) from 50 to 98 wt % structural units derived from one or more monomers comprising carboxyl groups;
   (ii) from 1 to 49 wt % structural units derived from one or more monomers comprising sulfonate moieties; and
   (iii) from 1 to 49 wt % structural units derived from one or more types of monomers selected from ether bond-containing monomers represented by formulas (I) and (II):

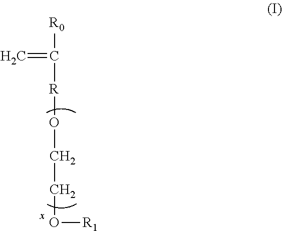

wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group;

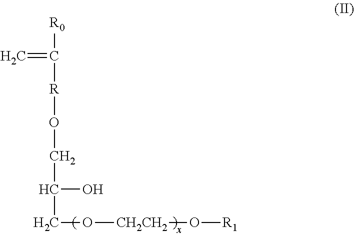

wherein in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group;
(b) from 3 wt % to 65 wt %, by weight of the composition, of linear alkyl benzene sulphonate (LAS); and
(c) from 3 wt % to 45 wt %, by weight of the composition, of soap powder.

In some embodiments, the carboxyl group-containing polymer comprises:
(i) from 68 to 97 wt %, preferably from 70 to 95%, more preferably from 72 to 92%, structural units derived from an acrylic acid-based monomer;
(ii) from 1 to 23 wt %, preferably from 3 to 22%, more preferably from 5 to 21%, structural units derived from a sulfonic acid group-containing monomer; and
(iii) from 1 to 20 wt %, preferably from 2 to 15%, more preferably from 3 to 10%, structural units derived from one or more types of monomers selected from ether bond-containing monomers represented by formulas (I) and (II).

In some embodiments, the carboxyl group-containing polymer comprises:
(i) the structure units as represented by formula (III):

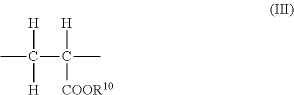

wherein R¹⁰ represents a hydrogen atom, a metal atom, an ammonium group, or an organic amine group;
(ii) the structure units derived from one or more monomers as represented by the formula (IV):

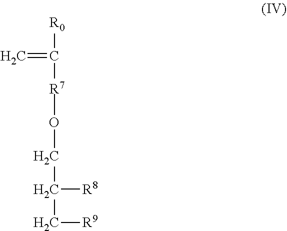

wherein R⁶ represents a hydrogen atom or a methyl group; R⁷ represents a CH₂ group, a CH₂CH₂ group, or a direct bond; R⁸ and R⁹ independently represent a hydroxyl group or —SO₃Z; Z represents a hydrogen atom, a metal atom, an ammonium group, or an organic amine group; and at least one of R⁸ and R⁹ is —SO₃Z; and
(iii) the structure units derived from one or more monomers as represented by the formula (II) wherein R⁰ is a hydrogen atom; R is a CH₂ group; x is 0; and R¹ is a C₁-C₄ alkyl group, preferably a butyl.

In some embodiments, the carboxyl group-containing polymer has a weight average molecular weight of from about 20,000 to 60,000, preferably from about 30,000 to 50,000, more preferably from about 33,000 to about 44,000, even more preferably from about 35,000 to about 42,000, and most preferably from about 36,000 to about 40,000.

In another aspect, the present invention relates to a laundry detergent product comprising the spray-dried particulate composition according to the present disclosure and an additional ingredient, wherein the additional ingredient may be selected from the group consisting of polymers, perfume, perfume encapsulates, surfactants, enzymes, bleach, bleach activators, phosphates, zeolite, silicates, carbonates, sodium chloride, chelants, hueing agents, dye transfer inhibitors, and any combinations thereof. Particularly, the additional ingredient may be in a form of agglomerate and/or spray-dried powder.

### BRIEF DESCRIPTION OF THE DRAWINGS

The embodiments set forth in the drawings are illustrative in nature and not intended to limit the invention defined by the claims. The following detailed description of the illustrative embodiments can be understood when read in conjunction with the following drawings, and in which:

FIG. 1 shows soap wt % in spray-dried powder as production time increases for the powders respectively containing the carboxyl group-containing polymer or acrylic acid/maleic acid copolymer.

### DETAILED DESCRIPTION OF THE INVENTION

As used herein, the articles “a” and “an” when used in a claim, are understood to mean one or more of what is claimed or described.

As used herein, the term “laundry detergent” means a liquid or solid composition, and includes, unless otherwise indicated, granular or powder-form all-purpose or “heavy-duty” washing agents, especially cleaning detergents as well as cleaning auxiliaries such as bleach additives or pre-treat types. In one embodiment, the laundry detergent is a solid laundry detergent composition, and preferably a free-flowing particulate laundry detergent composition (i.e., a granular detergent product).

As used herein, the terms “water hardness” or “hardness-tolerant” means uncomplexed calcium (i.e., Ca²⁺) arising from water and/or soils on dirty fabrics/materials; more generally and typically, “water hardness” also includes other uncomplexed cations (e.g., Mg²⁺⁾ having the potential to precipitate under alkaline conditions, and tends to diminish the surfactancy and cleaning capacity of surfactants. Further, the terms “high water hardness” or “elevated water hardness” can be used interchangeably and are relative terms for the purposes of the present invention, and are intended to mean at least “12 grams per gallon water (gpg, “American grain hardness” units) of calcium ion”.

As used herein, the term “average molecular weight” refers to the average molecular weight of the polymer chains in a polymer composition. Further, the “weight average molecular weight” (“M_{w}”) may be calculated using the equation:

$${M}_{w} = ( {Σ}_{i} {N}_{i} {{M}_{i}}^{2} ) / ( {Σ}_{i} {N}_{i} {{M}_{i}}^{2} )$$

Where Nᵢ is the number of molecules having a molecular weight Mᵢ. The weight average molecular weight must be measured by the method described in the Test Methods section.

As used herein, the term “anti-soil redeposition” or “anti-redeposition” means the ability of the polymer to prevent soil components from reattaching to fibers or materials in washing treatment using water. In the context of high hardness water conditions, the anti-soil redeposition ability, preferably, needs to be better than existing polyacrylate polymers, having lower molecular weight ranges, to achieve improved cleaning performance, for example, enhanced whiteness maintenance, must be measured by the method described in the Test Methods section.

### Spray-Dried Particulate Composition

The spray-dried particulate composition comprises from 0.1 wt % to 3 wt %, by weight of the composition, of a carboxyl group-containing polymer, from 3 wt % to 65 wt %, by weight of the composition, of a linear alkyl benzene sulphonate (LAS), and from 3 wt % to 45 wt %, by weight of the composition, of soap powder. Preferably, the spray-dried particulate composition is a laundry detergent composition.

In some embodiments, the spray-dried particulate composition comprises: (a) from 0.1 wt % to 2.5 wt %, preferably from 0.15 wt % to 2.2 wt %, more preferably from 0.2 wt % to 2.0 wt %, by weight of the composition, of the carboxyl group-containing polymer; (b) from 5 wt % to 60 wt %, preferably from 7 wt % to 55 wt %, more preferably from 9 wt % to 50 wt %, by weight of the composition, of LAS; and (c) from 4 wt % to 40 wt %, preferably from 5 wt % to 35 wt %, more preferably from 6 wt % to 30 wt %, by weight of the composition, of soap powder.

In some embodiments, the composition further comprises: (d) from 0 wt % to 5 wt %, by weight of the composition, of zeolite builder; and/or (e) from 0 wt % to 5 wt %, by weight of the composition, of phosphate builder; and/or (f) from 0 wt % to 30 wt %, by weight of the composition, of sodium carbonate; and/or (g) from 0 wt % to 70 wt %, by weight of the composition, of sodium sulfate; and/or (h) from 0 wt % to 20 wt %, by weight of the composition, of silicate; and/or (i) from 0% to 5% by weight of the composition, of a brightener.

In some embodiments, total surfactant content in the spray-dried particulate composition is from 10% to 80%, preferably from 12% to 70%, more preferably from 14% to 65%, most preferably from 16% to 60%, by weight of the composition.

In some embodiments, the particulate composition is a solid free-flowing composition.

In some embodiments, the particulate composition has a viscosity of from 0.5 to 2.5 cP, e.g., 0.5 cP, 1 cP, 1.5 cP, 2 cP, 2.5 cP or any ranges therebetween, at 50 s⁻¹.

In some embodiments, the particulate composition comprises less than 1%, preferably less than 0.5%, more preferably less than 0.1%, by weight of the composition, of acrylic acid/maleic acid copolymer.

In some embodiments, the particulate composition according to the present disclosure is a fully formulated laundry detergent product. In some other embodiments, the particulate laundry detergent composition according to the present disclosure is a portion of a fully formulated laundry detergent product. Particularly, the particulate composition according to the present disclosure may be mixed with a plurality of chemically different particles, such as spray-dried base detergent particles and/or agglomerated base detergent particles and/or extruded base detergent particles, in combination with one or more, typically two or more, or five or more, or even ten or more particles selected from: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as coloured noodles, needles, lamellae particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, preferably these enzyme granulates comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

### Spray-Dried Particle

Particularly, the spray-dried particle has a bulk density of from 350 g/l to 500 g/l. Typically, the spray-dried particle has a weight average particle size of from 400 micrometers to 450 micrometers. Typically, the spray-dried particle has a particle size distribution such that the geometric span is from 1.8 to 2.0.

The spray-dried particle may be prepared by a spray-drying process. In an typical embodiment, an aqueous mixture containing alkyl benzene sulphonate anionic detersive surfactant is prepared by preferably contacting alkyl benzene sulphonate paste with neutralizing agent. Then, carboxylate polymer and soap powder as well as, if present, carbonate (e.g. sodium carbonate) and silicate, may be added to the aqueous mixture. Subsequently, other ingredients including sodium sulphate are added into the aqueous mixture to form a crutcher mixture. Typically, the crutcher mixture is then spray-dried to form the spray-dried particle.

### Carboxyl Group-Containing Polymer

The carboxyl group-containing polymer includes a structure unit (i) at a level of from about 50% to about 98% by mass, a structure unit (ii) at a level of from about 1% to about 49% by mass, and a structure unit (iii) at a level of from about 1% to about 49% by mass based on 100% by mass of all structure units derived from all monomers in the carboxyl group-containing polymer.

Particularly, the carboxyl group-containing polymer comprises:
(i) from 50 to 98 wt % structural units derived from one or more monomers comprising carboxyl groups;
(ii) from 1 to 49 wt % structural units derived from one or more monomers comprising sulfonate moieties; and
(iii) from 1 to 49 wt % structural units derived from one or more types of monomers selected from ether bond-containing monomers represented by formulas (I) and (II):

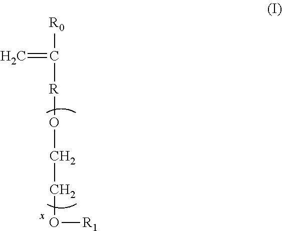

wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group;

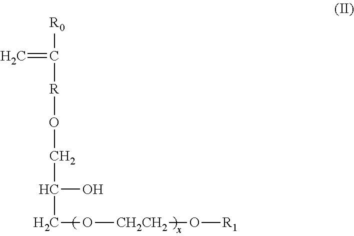

wherein in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group.

More particularly, the carboxyl group-containing polymer comprises:
(i) the structure units as represented by formula (III):

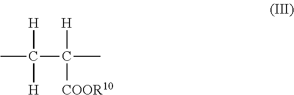

wherein R¹⁰ represents a hydrogen atom, a metal atom, an ammonium group, or an organic amine group;
(ii) the structure units derived from one or more monomers as represented by the formula (IV):

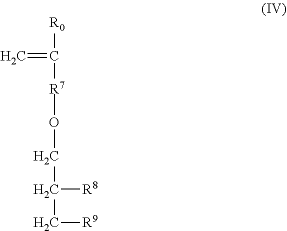

wherein R⁶ represents a hydrogen atom or a methyl group; R⁷ represents a CH₂ group, a CH₂CH₂ group, or a direct bond; R⁸ and R⁹ independently represent a hydroxyl group or —SO₃Z; Z represents a hydrogen atom, a metal atom, an ammonium group, or an organic amine group; and at least one of R⁸ and R⁹ is —SO₃Z; and
(iii) the structure units derived from one or more monomers as represented by the formula (II) wherein R⁰ is a hydrogen atom; R is a CH₂ group; x is 0; and R¹ is a C₁-C₄ alkyl group, preferably a butyl.

In some embodiments, a structure unit (i) at a level of from about 55% to about 95%, preferably from about 65% to about 90%, more preferably from about 70% to about 85%, by mass, a structure unit (ii) at a level of from about 1% to about 40%, preferably from about 5% to about 30%, more preferably from about 10% to about 20%, by mass, and a structure unit (iii) at a level of from about 1% to about 30%, preferably from about 2% to about 20%, more preferably from about 3% to about 10%, by mass based on 100% by mass of all structure units.

Examples of the monomers comprising carboxyl groups include acrylic acid and salts thereof, preferably the sodium salt of acylic acid.

Examples of the monomers comprising sulfonate moieties include compounds having a carbon-carbon double bond and a sulfonic acid (salt) group. Specific examples thereof include vinylsulfonic acid, styrenesulfonic acid, (meth)allylsulfonic acid, 3-(meth)allyloxy-2-hydroxypropanesulfonic acid, 3-(meth)allyloxy-1-hydroxypropanesulfonic acid, 2-(meth)allyloxyethylenesulfonic acid, 2-acrylamide-2-methylpropanesulfonic acid, and salts of these.

### Soap Powders

The soap used in the present invention comprise one or more C₁₀-C₂₂ fatty acids or alkali metal salts thereof. Such alkali metal salts include monovalent or divalent alkali metal salts, such as sodium, potassium, lithium and/or magnesium salts of fatty acids, and ammonium and/or alkylammonium salts of fatty acids, preferably sodium salts. Preferred fatty acids or salts thereof for use herein contain from 10 to 20 carbon atoms, more preferably from 12 to 18 carbon atoms. In a particularly preferred embodiment of the present invention, the soap for use in the cleansing composition are formed substantially of, or more preferably consist essentially of, fatty acids or salts having from about 10 to about 20 carbon atoms, more preferably from about 12 to about 18 carbon atoms. Exemplary fatty acids that can be used may be selected from caprylic acid, capric acid, lauric acid, myristic acid, myristoleic acid, palmitic acid, palmitoleic acid, sapienic acid, stearic acid, oleic acid, elaidic acid, vaccenic acid, linoleic acid, linoelaidic acid, α-linoelaidic acid, arachidic acid, arachidonic acid, eicosapentaenoic acid, behenic acid, erucic acid, and docosahexaenoic acid, and mixtures thereof.

Preferably, the soap may be in the format of powder which is preferably characterized by a particle size in the range of about 50 microns to about 500 microns, e.g., 50 microns, 100 microns, 150 microns, 200 microns, 250 microns, 300 microns, 400 microns, 500 microns or any ranges therebetween. The particulate composition of the present invention may contain a mixture of soap particles of different particle sizes. The soap powder used in the present invention can be made by any known approaches. For example, the cleaning composition may contain ground soap powder which are made by grinding the Palmosalt NP021 soap powder sourced from Taiko Palm Oleo Zhangjiagang Co., Ltd, using a pin mill under N2 gas or dry ice for cooling down the soap particles during the grinding process.

### Detergent Ingredients

In some embodiments, suitable laundry detergent compositions may comprise a detergent ingredient selected from: detersive surfactant, such as anionic detersive surfactants, non-ionic detersive surfactants, cationic detersive surfactants, zwitterionic detersive surfactants and amphoteric detersive surfactants; polymers, such as carboxylate polymers, soil release polymer, anti-redeposition polymers, cellulosic polymers and care polymers; bleach, such as sources of hydrogen peroxide, bleach activators, bleach catalysts and pre-formed peracids; photobleach, such as such as zinc and/or aluminium sulphonated phthalocyanine; enzymes, such as proteases, amylases, cellulases, lipases; zeolite builder; phosphate builder; co-builders, such as citric acid and citrate; carbonate, such as sodium carbonate and sodium bicarbonate; sulphate salt, such as sodium sulphate; silicate salt such as sodium silicate; chloride salt, such as sodium chloride; brighteners; chelants; hueing agents; dye transfer inhibitors; dye fixative agents; perfume; silicone; fabric softening agents, such as clay; flocculants, such as polyethyleneoxide; suds suppressors; and any combination thereof.

### Detersive Surfactant

Suitable detersive surfactants include anionic detersive surfactants, non-ionic detersive surfactant, cationic detersive surfactants, zwitterionic detersive surfactants and amphoteric detersive surfactants. Suitable detersive surfactants may be linear or branched, substituted or un-substituted, and may be derived from petrochemical material or biomaterial.

Suitable anionic detersive surfactants include sulphonate and sulphate detersive surfactants.

Suitable sulphonate detersive surfactants include methyl ester sulphonates, alpha olefin sulphonates, alkyl benzene sulphonates, especially alkyl benzene sulphonates, preferably C₁₀₋₁₃ alkyl benzene sulphonate. Suitable alkyl benzene sulphonate (LAS) is obtainable, preferably obtained, by sulphonating commercially available linear alkyl benzene (LAB); suitable LAB includes low 2-phenyl LAB, other suitable LAB include high 2-phenyl LAB, such as those supplied by Sasol under the tradename Hyblene®.

Suitable sulphate detersive surfactants include alkyl sulphate, preferably C₈₋₁₈ alkyl sulphate, or predominantly C₁₂ alkyl sulphate.

A preferred sulphate detersive surfactant is alkyl alkoxylated sulphate, preferably alkyl ethoxylated sulphate, preferably a C₈₋₁₈ alkyl alkoxylated sulphate, preferably a C₈₋₁₈ alkyl ethoxylated sulphate, preferably the alkyl alkoxylated sulphate has an average degree of alkoxylation of from 0.5 to 20, preferably from 0.5 to 10, preferably the alkyl alkoxylated sulphate is a C₈₋₁₈ alkyl ethoxylated sulphate having an average degree of ethoxylation of from 0.5 to 10, preferably from 0.5 to 5, more preferably from 0.5 to 3 and most preferably from 0.5 to 1.5.

The alkyl sulphate, alkyl alkoxylated sulphate and alkyl benzene sulphonates may be linear or branched, substituted or un-substituted, and may be derived from petrochemical material or biomaterial.

Other suitable anionic detersive surfactants include alkyl ether carboxylates.

Suitable anionic detersive surfactants may be in salt form, suitable counter-ions include sodium, calcium, magnesium, amino alcohols, and any combination thereof. A preferred counter-ion is sodium.

Suitable non-ionic detersive surfactants are selected from the group consisting of: C₈-C₁₈ alkyl ethoxylates, such as, NEODOL® non-ionic surfactants from Shell; C₆-C₁₂ alkyl phenol alkoxylates wherein preferably the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; alkylpolysaccharides, preferably alkylpolyglycosides; methyl ester ethoxylates; polyhydroxy fatty acid amides; ether capped poly(oxyalkylated) alcohol surfactants; and mixtures thereof.

Suitable non-ionic detersive surfactants are alkylpolyglucoside and/or an alkyl alkoxylated alcohol.

Suitable non-ionic detersive surfactants include alkyl alkoxylated alcohols, preferably C₈₋₁₈ alkyl alkoxylated alcohol, preferably a C₈₋₁₈ alkyl ethoxylated alcohol, preferably the alkyl alkoxylated alcohol has an average degree of alkoxylation of from 1 to 50, preferably from 1 to 30, or from 1 to 20, or from 1 to 10, preferably the alkyl alkoxylated alcohol is a C₈₋₁₈ alkyl ethoxylated alcohol having an average degree of ethoxylation of from 1 to 10, preferably from 1 to 7, more preferably from 1 to 5 and most preferably from 3 to 7. The alkyl alkoxylated alcohol can be linear or branched, and substituted or un-substituted.

Suitable nonionic detersive surfactants include secondary alcohol-based detersive surfactants.

Suitable cationic detersive surfactants include alkyl pyridinium compounds, alkyl quaternary ammonium compounds, alkyl quaternary phosphonium compounds, alkyl ternary sulphonium compounds, and mixtures thereof.

Preferred cationic detersive surfactants are quaternary ammonium compounds having the general formula:

$$( R ) ( {R}_{1} ) ( {R}_{2} ) ( {R}_{3} ) {N}^{+} {X}^{-}$$

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include: halides, preferably chloride; sulphate; and sulphonate.

Suitable zwitterionic detersive surfactants include amine oxides and/or betaines.

### Additional Ingredients

The particulate composition according to the present disclosure may be combined with an additional ingredient. The additional ingredients may be in the form of particulates, such as aggolomerates and/or spray-dried powder. Alternatively, the additional ingredients may be sprayed onto the surface of the particulate composition according to the present disclosure. Preferably, the additional ingredient may be selected from the group consisting of polymers, perfume, perfume encapsulates, surfactants, enzymes, brighteners, bleach, bleach activators, phosphates, zeolite, silicates, carbonates, sodium chloride, and any combinations thereof.

Suitable polymers include carboxylate polymers, soil release polymers, anti-redeposition polymers, cellulosic polymers, care polymers and any combination thereof.

The composition may comprise a soil release polymer. A suitable soil release polymer has a structure as defined by one of the following structures (I), (II) or (III):

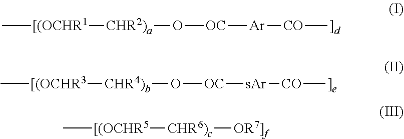

wherein:
a, b and c are from 1 to 200;
d, e and f are from 1 to 50;
Ar is a 1,4-substituted phenylene;
sAr is 1,3-substituted phenylene substituted in position 5 with SO₃Me;
Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;
R¹, R², R³, R⁴, R⁵ and R⁶ are independently selected from H or C₁-C₁₅ n- or iso-alkyl; and R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable soil release polymers are sold by Clariant under the TexCare® series of polymers, e.g. TexCare® SRN240 and TexCare® SRA300. Other suitable soil release polymers are sold by Solvay under the Repel-o-Tex® series of polymers, e.g. Repel-o-Tex® SF2 and Repel-o-Tex® Crystal.

Suitable anti-redeposition polymers include polyethylene glycol polymers and/or polyethyleneimine polymers.

Suitable polyethylene glycol polymers include random graft co-polymers comprising: (i) hydrophilic backbone comprising polyethylene glycol; and (ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof. Suitable polyethylene glycol polymers have a polyethylene glycol backbone with random grafted polyvinyl acetate side chains. The average molecular weight of the polyethylene glycol backbone can be in the range of from 2,000 Da to 20,000 Da, or from 4,000 Da to 8,000 Da. The molecular weight ratio of the polyethylene glycol backbone to the polyvinyl acetate side chains can be in the range of from 1:1 to 1:5, or from 1:1.2 to 1:2. The average number of graft sites per ethylene oxide units can be less than 1, or less than 0.8, the average number of graft sites per ethylene oxide units can be in the range of from 0.5 to 0.9, or the average number of graft sites per ethylene oxide units can be in the range of from 0.1 to 0.5, or from 0.2 to 0.4. A suitable polyethylene glycol polymer is Sokalan HP22.

Suitable cellulosic polymers are selected from alkyl cellulose, alkyl alkoxyalkyl cellulose, carboxyalkyl cellulose, alkyl carboxyalkyl cellulose, sulphoalkyl cellulose, more preferably selected from carboxymethyl cellulose, methyl cellulose, methyl hydroxyethyl cellulose, methyl carboxymethyl cellulose, and mixtures thereof.

Suitable carboxymethyl celluloses have a degree of substitution greater than 0.65 and a degree of blockiness greater than 0.45.

Suitable care polymers include cellulosic polymers that are cationically modified or hydrophobically modified. Such modified cellulosic polymers can provide anti-abrasion benefits and dye lock benefits to fabric during the laundering cycle. Suitable cellulosic polymers include cationically modified hydroxyethyl cellulose.

Other suitable care polymers include dye lock polymers, for example the condensation oligomer produced by the condensation of imidazole and epichlorhydrin, preferably in ratio of 1:4:1. A suitable commercially available dye lock polymer is Polyquart® FDI (Cognis).

Other suitable care polymers include amino-silicone, which can provide fabric feel benefits and fabric shape retention benefits.

Suitable bleach includes sources of hydrogen peroxide, bleach activators, bleach catalysts, pre-formed peracids and any combination thereof. A particularly suitable bleach includes a combination of a source of hydrogen peroxide with a bleach activator and/or a bleach catalyst.

Suitable sources of hydrogen peroxide include sodium perborate and/or sodium percarbonate.

Suitable bleach activators include tetra acetyl ethylene diamine and/or alkyl oxybenzene sulphonate.

Suitable enzymes include lipases, proteases, cellulases, amylases and any combination thereof.

Suitable proteases include metalloproteases and/or serine proteases. Examples of suitable neutral or alkaline proteases include: subtilisins (EC 3.4.21.62); trypsin-type or chymotrypsin-type proteases; and metalloproteases. The suitable proteases include chemically or genetically modified mutants of the aforementioned suitable proteases.

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark), those sold under the tradename Maxatase®, Maxacal®, Maxapem®, Preferenz P® series of proteases including Preferenz® P280, Preferenz® P281, Preferenz® P2018-C, Preferenz® P2081-WE, Preferenz® P2082-EE and Preferenz® P2083-A/J, Properase®, Purafect®, Purafect Prime®, Purafect Ox®, FN3®, FN4®, Excellase® and Purafect OXP® by DuPont, those sold under the tradename Opticlean® and Optimase® by Solvay Enzymes, those available from Henkel/Kemira; and KAP (Bacillus alkalophilus subtilisin with mutations A230V+S256G+S259N) from Kao.

Suitable amylases are derived from AA560 alpha amylase endogenous to Bacillus sp. DSM 12649, preferably having the following mutations: R118K, D183*, G184*, N195F, R320K, and/or R458K. Suitable commercially available amylases include Stainzyme®, Stainzyme® Plus, Natalase, Termamyl®, Termamyl® Ultra, Liquezyme® SZ, Duramyl®, Everest® (all Novozymes) and Spezyme® AA, Preferenz S® series of amylases, Purastar® and Purastar® Ox Am, Optisize® HT Plus (all Du Pont).

Suitable cellulases include those of bacterial or fungal origin. Chemically modified or protein engineered mutants are also suitable. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum.

Commercially available cellulases include Celluzyme®, Carezyme®, and Carezyme® Premium, Celluclean® and Whitezyme® (Novozymes A/S), Revitalenz® series of enzymes (Du Pont), and Biotouch® series of enzymes (AB Enzymes). Suitable commercially available cellulases include Carezyme® Premium, Celluclean® Classic.

Suitable lipases include those of bacterial, fungal or synthetic origin, and variants thereof. Chemically modified or protein engineered mutants are also suitable. Examples of suitable lipases include lipases from Humicola (synonym Thermomyces), e.g., from H. lanuginosa (T. lanuginosus).

In one aspect, the lipase is a first-wash lipase, preferably a variant of the wild-type lipase from Thermomyces lanuginosus comprising T231R and/or N233R mutations. Preferred lipases include those sold under the tradenames Lipex®, Lipolex® and Lipoclean® by Novozymes, Bagsvaerd, Denmark.

Other suitable enzymes are bleaching enzymes, such as peroxidases/oxidases, which include those of plant, bacterial or fungal origin and variants thereof. Commercially available peroxidases include Guardzyme® (Novozymes A/S). Other suitable enzymes include choline oxidases and perhydrolases such as those used in Gentle Power Bleach™ Other suitable enzymes include pectate lyases sold under the tradenames X-Pect®, Pectaway® (from Novozymes A/S, Bagsvaerd, Denmark) and PrimaGreen® (DuPont) and mannanases sold under the tradenames Mannaway® (Novozymes A/S, Bagsvaerd, Denmark), and Mannastar® (Du Pont).

The composition may comprise zeolite builder. The composition may comprise from 0 wt % to 5 wt % zeolite builder, or 3 wt % zeolite builder. The composition may even be substantially free of zeolite builder; substantially free means “no deliberately added”. Typical zeolite builders include zeolite A, zeolite P and zeolite MAP.

The composition may comprise phosphate builder. The composition may comprise from 0 wt % to 5 wt % phosphate builder, or to 3 wt %, phosphate builder. The composition may even be substantially free of phosphate builder; substantially free means “no deliberately added”. A typical phosphate builder is sodium tri-polyphosphate.

The composition may comprise carbonate salt. The composition may comprise from 0 wt % to 10 wt % carbonate salt, or to 5 wt % carbonate salt. The composition may even be substantially free of carbonate salt; substantially free means “no deliberately added”. Suitable carbonate salts include sodium carbonate and sodium bicarbonate.

The composition may comprise silicate salt. The composition may comprise from 0 wt % to 10 wt % silicate salt, or to 5 wt % silicate salt. A preferred silicate salt is sodium silicate, especially preferred are sodium silicates having a Na₂O:SiO₂ ratio of from 1.0 to 2.8, preferably from 1.6 to 2.0.

A suitable sulphate salt is sodium sulphate.

Suitable fluorescent brighteners include: di-styryl biphenyl compounds, e.g. Tinopal® CBS-X, di-amino stilbene di-sulfonic acid compounds, e.g. Tinopal® DMS pure Xtra and Blankophor® HRH, and Pyrazoline compounds, e.g. Blankophor® SN, and coumarin compounds, e.g. Tinopal® SWN. Preferred brighteners are: sodium 2 (4-styryl-3-sulfophenyl)-2H-napthol[1,2-d]triazole, disodium 4,4′-bis{[(4-anilino-6-(N methyl-N-2 hydroxyethyl)amino 1,3,5-triazin-2-yl)]; amino}stilbene-2-2′ disulfonate, disodium 4,4′-bis{[(4-anilino-6-morpholino-1,3,5-triazin-2-yl)]amino}stilbene-2-2′ disulfonate, and disodium 4,4′-bis(2-sulfostyryl)biphenyl. A suitable fluorescent brightener is C.I. Fluorescent Brightener 260, which may be used in its beta or alpha crystalline forms, or a mixture of these forms.

The composition may also comprise a chelant selected from: diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid). A preferred chelant is ethylene diamine-N′N′-disuccinic acid (EDDS) and/or hydroxyethane diphosphonic acid (HEDP). The composition preferably comprises ethylene diamine-N′N′-disuccinic acid or salt thereof. Preferably the ethylene diamine-N′N′-disuccinic acid is in S,S enantiomeric form. Preferably the composition comprises 4,5-dihydroxy-m-benzenedisulfonic acid disodium salt. Preferred chelants may also function as calcium carbonate crystal growth inhibitors such as: 1-hydroxyethanediphosphonic acid (HEDP) and salt thereof; N,N-dicarboxymethyl-2-aminopentane-1,5-dioic acid and salt thereof; 2-phosphonobutane-1,2,4-tricarboxylic acid and salt thereof; and combination thereof.

Suitable hueing agents include small molecule dyes, typically falling into the Colour Index (C.I.) classifications of Acid, Direct, Basic, Reactive (including hydrolysed forms thereof) or Solvent or Disperse dyes, for example classified as Blue, Violet, Red, Green or Black, and provide the desired shade either alone or in combination. Preferred such hueing agents include Acid Violet 50, Direct Violet 9, 66 and 99, Solvent Violet 13 and any combination thereof.

Suitable dye transfer inhibitors include polyamine N-oxide polymers, copolymers of N-vinylpyrrolidone and N-vinylimidazole, polyvinylpyrrolidone, polyvinyloxazolidone, polyvinylimidazole and mixtures thereof. Preferred are poly(vinyl pyrrolidone), poly(vinylpyridine betaine), poly(vinylpyridine N-oxide), poly(vinyl pyrrolidone-vinyl imidazole) and mixtures thereof. Suitable commercially available dye transfer inhibitors include PVP-K15 and K30 (Ashland), Sokalan® HP165, HP50, HP53, HP59, HP56K, HP56, HP66 (BASF), Chromabond® S-400, S403E and S-100 (Ashland).

Suitable perfumes comprise perfume materials selected from the group: (a) perfume materials having a ClogP of less than 3.0 and a boiling point of less than 250° C. (quadrant 1 perfume materials); (b) perfume materials having a ClogP of less than 3.0 and a boiling point of 250° C. or greater (quadrant 2 perfume materials); (c) perfume materials having a ClogP of 3.0 or greater and a boiling point of less than 250° C. (quadrant 3 perfume materials); (d) perfume materials having a ClogP of 3.0 or greater and a boiling point of 250° C. or greater (quadrant 4 perfume materials); and (e) mixtures thereof.

It may be preferred for the perfume to be in the form of a perfume delivery technology. Such delivery technologies further stabilize and enhance the deposition and release of perfume materials from the laundered fabric. Such perfume delivery technologies can also be used to further increase the longevity of perfume release from the laundered fabric. Suitable perfume delivery technologies include: perfume microcapsules, pro-perfumes, polymer assisted deliveries, molecule assisted deliveries, fiber assisted deliveries, amine assisted deliveries, cyclodextrin, starch encapsulated accord, zeolite and other inorganic carriers, and any mixture thereof.

Suitable silicones include polydimethylsiloxane and amino-silicones.

### Process for Making the Solid Composition

Typically, the spray-dried particles of the composition can be prepared by any suitable method.

Typically, a suitable spray-drying process comprises the step of forming an aqueous slurry mixture, transferring it through at least one pump, preferably two pumps, to a pressure nozzle. Atomizing the aqueous slurry mixture into a spray-drying tower and drying the aqueous slurry mixture to form spray-dried particles. Preferably, the spray-drying tower is a counter-current spray-drying tower, although a co-current spray-drying tower may also be suitable.

Typically, the spray-dried powder is subjected to cooling, for example an air lift. Typically, the spray-drying powder is subjected to particle size classification, for example a sieve, to obtain the desired particle size distribution. Preferably, the spray-dried powder has a particle size distribution such that weight average particle size is in the range of from 300 micrometers to 500 micrometers, and less than 10 wt % of the spray-dried particles have a particle size greater than 2360 micrometers.

It may be preferred to heat the aqueous slurry mixture to elevated temperatures prior to atomization into the spray-drying tower.

It may be preferred for anionic surfactant, such as linear alkyl benzene sulphonate, to be introduced into the spray-drying process after the step of forming the aqueous slurry mixture: for example, introducing an acid precursor to the aqueous slurry mixture after the pump.

It may be preferred for a gas, such as air, to be introduced into the spray-drying process after the step of forming the aqueous slurry.

It may be preferred for any inorganic ingredients, such as sodium sulphate and sodium carbonate, if present in the aqueous slurry mixture, to be micronized to a small particle size.

It may be preferred for ingredients such as polymer and/or non-ionic detersive surfactant and/or perfume to be sprayed onto base detergent particles, such as spray-dried base detergent particles and/or agglomerated base detergent particles. Typically, this spray-on step is carried out in a tumbling drum mixer.

### Method of Laundering Fabric

The method of laundering fabric comprises the step of contacting the solid composition to water to form a wash liquor, and laundering fabric in said wash liquor. Typically, the wash liquor has a temperature of above 0° C. to 90° C., or to 60° C., or to 40° C., or to 30° C., or to 20° C. The fabric may be contacted to the water prior to, or after, or simultaneous with, contacting the solid composition with water. Typically, the wash liquor is formed by contacting the laundry detergent to water in such an amount so that the concentration of laundry detergent composition in the wash liquor is from 0.2 g/l to 20 g/l, or from 0.5 g/l to 10 g/l, or to 5.0 g/l. The method of laundering fabric can be carried out in a front-loading automatic washing machine, top loading automatic washing machines, including high efficiency automatic washing machines, or suitable hand-wash vessels. Typically, the wash liquor comprises 90 litres or less, or 60 litres or less, or 15 litres or less, or 10 litres or less of water. Typically, 200 g or less, or 150 g or less, or 100 g or less, or 50 g or less of laundry detergent composition is contacted to water to form the wash liquor.

### EXAMPLES

### Example 1: Reduced Viscosity of Slurry Containing Carboxyl Group-Containing Polymer

Compared to Slurry Containing Acrylic Acid/Maleic acid Copolymer Six (6) sample slurries for particulate detergent compositions containing the following ingredients as shown in Table 1 were prepared. These slurries were spray-dried to provide particulate detergent compositions as shown in Table 2. Particularly, an aqueous mixture containing alkyl benzene sulphonate is prepared by contacting alkyl benzene sulphonate paste with a neutralizing agent. Then, carboxylate polymer, soap powder, sodium carbonate and silicate were added to the aqueous mixture. Subsequently, other ingredients including sodium sulphate were added into the aqueous mixture to form a crutcher mixture. The crutcher mixture was then spray-dried to form the spray-dried particle. Samples containing the acrylic acid/maleic acid copolymer or the carboxyl group-containing polymer (i.e. Samples 2, 3, 5 and 6) can provide fine powders without having any negative on solubility and hand feel.

TABLE 1

| Ingredients | | | | | | |
|---|---|---|---|---|---|---|
| (weight % of active) | Sample 1 | Sample 2 | Sample 3 | Sample 4 | Sample 5 | Sample 6 |
| Carboxyl group- | — | — | 0.3 | — | — | 0.6 |
| containing polymer¹ | | | | | | |
| Acrylic acid/maleic | — | 0.3 | — | — | 0.6 | — |
| acid copolymer² | | | | | | |
| LAS | 16.0 | 16.0 | 16.0 | 22.6 | 22.6 | 22.6 |
| Soap powder³ | 15.9 | 15.9 | 15.9 | 9.3 | 9.3 | 9.3 |
| Silicate | 7.3 | 7.3 | 7.3 | 7.3 | 7.3 | 7.3 |
| Sodium carbonate | 1.5 | 1.5 | 1.5 | 1.5 | 1.5 | 1.5 |
| Sodium sulphate | 17.1 | 16.8 | 16.8 | 18.0 | 17.4 | 17.4 |
| Total water | 40.0 | 40.0 | 40.0 | 40.0 | 40.0 | 40.0 |
| Miscellaneous | Balance | Balance | Balance | Balance | Balance | Balance |

¹HGLS 650 from Nippon Shokubai with monomers of AA/HAPS/PAB at a weight ratio of 80:15:5.
²Sokalan ® CP5 from BASF
³A soap powder sourced from Ningbo Jiahe New Materials Technology Ltd. Co.

TABLE 2

| Ingredients | | | | | | |
|---|---|---|---|---|---|---|
| (weight % of active) | Sample 1 | Sample 2 | Sample 3 | Sample 4 | Sample 5 | Sample 6 |
| Carboxyl group- | — | — | 0.5 | — | — | 1.0 |
| containing polymer¹ | | | | | | |
| Acrylic acid/maleic | — | 0.5 | — | — | 1.0 | — |
| acid copolymer² | | | | | | |
| LAS | 26.2 | 26.2 | 26.2 | 37.0 | 37.0 | 37.0 |
| Soap powder | 26.0 | 26.0 | 26.0 | 15.1 | 15.1 | 15.1 |
| Silicate | 11.9 | 11.9 | 11.9 | 11.9 | 11.9 | 11.9 |
| Sodium carbonate | 2.5 | 2.5 | 2.5 | 2.5 | 2.5 | 2.5 |
| Sodium sulphate | 28.0 | 27.5 | 27.5 | 29.5 | 28.4 | 28.4 |
| Moisture | 2.0 | 2.0 | 2.0 | 2.0 | 2.0 | 2.0 |
| Miscellaneous | Balance | Balance | Balance | Balance | Balance | Balance |

¹HGLS 650 from Nippon Shokubai with monomers of AA/HAPS/PAB at a weight ratio of 80:15:5.
²Sokalan ® CP5 from BASF
3 A soap powder sourced from Ningbo Jiahe New Materials Technology Ltd. Co.

Viscosity of the sample slurries (Pa·s under 20 s⁻¹, 50 s⁻¹ and 100 s⁻¹) were determined with Malvern 10 Kinexus Lab+ rotational rheometer with a cone-to-plate geometry at 60° C. Particularly, a small amount of paste mixture was gently loaded onto the bottom plate and lower down the upper cone to 1 mm gap, the loaded sample was then trimmed using a spatula. Then a flow ramp test was conducted with a shear rate range from 1 to 500 s⁻¹. The results clearly indicate that the replacement of the acrylic acid/maleic acid copolymer with the carboxyl group-containing polymer significantly reduces the viscosity of the slurries.

TABLE 3

| | Sample 1 | Sample 2 | Sample 3 | Sample 4 | Sample 5 | Sample 6 |
|---|---|---|---|---|---|---|
| Weight % of carboxyl | — | — | 0.5 | — | — | 1.0 |
| group-containing | | | | | | |
| polymer in powder | | | | | | |
| Weight % of acrylic | — | 0.5 | — | — | 1.0 | — |
| acid/maleic acid | | | | | | |
| copolymer in powder | | | | | | |
| Viscosity | 3.9 | 5.2 | 3.7 | 4.9 | 7.7 | 2.7 |
| (Pa · s under 20 s⁻¹) | | | | | | |
| Viscosity | 1.6 | 3.2 | 1.7 | 2.8 | 3.0 | 1.7 |
| (Pa · s under 50 s⁻¹) | | | | | | |
| Viscosity | 0.9 | 2.1 | 0.9 | 1.8 | 2.2 | 1.2 |
| (Pa · s under 100 s⁻¹) | | | | | | |

### Example 2: Does-dependent Effect of Carboxyl Group-containing Polymer in Adjusting Viscosity of Slurry Containing Such Polymer

Four (4) sample slurries for particulate detergent compositions were prepared containing various levels of the carboxyl group-containing polymer as shown in Table 4. Similarly as in Example 1, these slurries were spray-dried to provide particulate detergent compositions as shown in Table 5. All samples can provide fine powders without having any negative on solubility and hand feel.

TABLE 4

| Ingredients | | | | |
|---|---|---|---|---|
| (weight % of active) | Sample 3 | Sample 7 | Sample 8 | Sample 9 |
| Carboxyl group- | 0.3 | 0.6 | 1.9 | 3.2 |
| containing polymer¹ | | | | |
| LAS | 16.0 | 16.0 | 16.0 | 16.0 |
| Soap powder² | 15.9 | 15.9 | 15.9 | 15.9 |
| Silicate | 7.3 | 7.3 | 7.3 | 7.3 |
| Sodium carbonate | 1.5 | 1.5 | 1.5 | 1.5 |
| Sodium sulphate | 16.8 | 16.5 | 15.2 | 14.0 |
| Total water | 40.0 | 40.0 | 40.0 | 40.0 |
| Miscellaneous | Balance | Balance | Balance | Balance |

¹HGLS 650 from Nippon Shokubai with monomers of AA/HAPS/PAB at a weight ratio of 80:15:5.
²A soap powder sourced from Ningbo Jiahe New Materials Technology Ltd. Co.

TABLE 5

| Ingredients | | | | |
|---|---|---|---|---|
| (weight % of active) | Sample 3 | Sample 7 | Sample 8 | Sample 9 |
| Carboxyl group- | 0.5 | 1.0 | 3.1 | 5.2 |
| containing polymer¹ | | | | |
| LAS | 26.2 | 26.2 | 26.2 | 26.2 |
| Soap powder² | 26.0 | 26.0 | 26.0 | 26.0 |
| Silicate | 11.9 | 11.9 | 11.9 | 11.9 |
| Sodium carbonate | 2.5 | 2.5 | 2.5 | 2.5 |
| Sodium sulphate | 27.5 | 26.9 | 24.9 | 22.8 |
| Moisture | 2.0 | 2.0 | 2.0 | 2.0 |
| Miscellaneous | Balance | Balance | Balance | Balance |

¹HGLS 650 from Nippon Shokubai with monomers of AA/HAPS/PAB at a weight ratio of 80:15:5.
²A soap powder sourced from Ningbo Jiahe New Materials Technology Ltd. Co.

Viscosity of the sample slurries (Pa·s under 20 s⁻¹, 50 s⁻¹ and 100 s⁻¹) were determined similarly as in Example 1, and shown in the following table. The results indicate that, when the wt % of the carboxyl group-containing polymer is within an appropriate range (such as, less than 3.1 wt %), the viscosity of slurries is kept at a relatively low level.

TABLE 6

| | Sample 3 | Sample 7 | Sample 8 | Sample 9 |
|---|---|---|---|---|
| Weight % of Carboxyl | 0.5 | 1.0 | 3.1 | 5.2 |
| group-containing | | | | |
| polymer in powder | | | | |
| Viscosity | 3.7 | 3.5 | 5.3 | 8.2 |
| (Pa · sunder 20 s⁻¹) | | | | |
| Viscosity | 1.7 | 1.7 | 3.3 | 5.1 |
| (Pa · sunder 50 s⁻¹) | | | | |
| Viscosity | 0.9 | 1.1 | 2.2 | 3.2 |
| (Pa · sunder 100 s⁻¹) | | | | |

### Example 3: Improved Converting Efficiency of Blown Powder Containing Soap and Carboxyl Group-containing Polymer at Plant-Scale

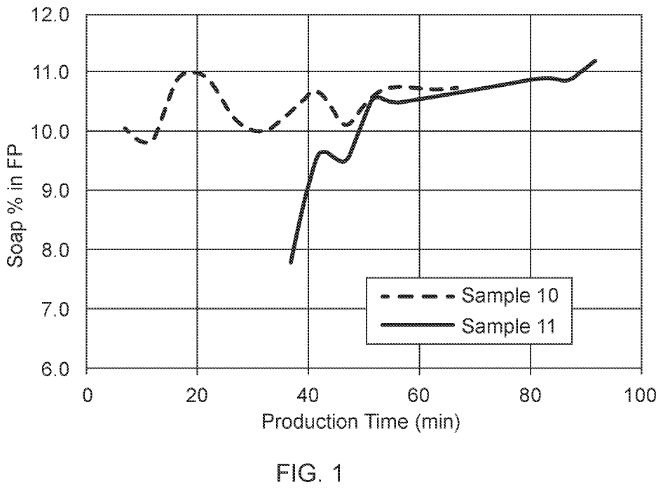

At plant-scale, not all the added soap would be present in the spray-dried powder because some of the soap are suspended in the air as fine particulates and lost to the environment. In order to evaluate if carboxyl group-containing polymer can improve the converting efficacy of soap, two (2) sample slurries of particulate detergent compositions containing the carboxyl group-containing polymer or acrylic acid/maleic acid copolymer were prepared. These slurries were converted in a plant-scale spray-drying tower (Topseller Chemicals Company Limited, Shandong, China) to provide particulate detergent compositions as shown in Table 7. FIG. 1 shows that Sample 10 containing the carboxyl group-containing polymer achieved to a much higher concentration of soap with a significant shorter production time compared to the formulation containing the acrylic acid/maleic acid copolymer, even though the slurry soap composition was lower. This suggests that the formulation containing the carboxyl group-containing polymer provides a much higher soap converting efficiency compared to the formulation containing the acrylic acid/maleic acid copolymer.

TABLE 7

| Ingredients | | |
|---|---|---|
| (weight % of active) | Sample 10 | Sample 11 |
| Carboxyl group-containing | 0.8 | — |
| polymer¹ | | |
| Acrylic acid/maleic acid | — | 2.5 |
| copolymer² | | |
| LAS | 9.9 | 9.9 |
| Soap powder³ | 11.6 | 12.3 |
| Silicate | 7.4 | 6.5 |
| Sodium carbonate | 10.5 | 10.5 |
| Brightener | 0.2 | 0.2 |
| Total water | 1.5 | 1.5 |
| Sodium sulphate | Balance | Balance |

¹HGLS 650 from Nippon Shokubai with monomers of AA/HAPS/PAB at a weight ratio of 80:15:5.
²Sokalan ® CP5 from BASF
³A soap powder sourced from Ningbo Jiahe New Materials Technology Ltd. Co.

### Example 4: Exemplary Granular Laundry Detergent Compositions

The exemplary formulations as shown in Table 8 are made for granular laundry detergent.

TABLE 8

| Ingredients (wt %) | A | B | C | D | E | F | G | H |
|---|---|---|---|---|---|---|---|---|
| LAS (Non-sulphated | 7 | 9 | 9 | 25 | 12 | 35 | 14 | 10.5 |
| anionic surfactant) | | | | | | | | |
| Mid-cut AS or Coconut | 2.2 | 1.5 | 1.5 | 2.2 | 1.0 | 1.0 | 0.7 | 1.5 |
| AS | | | | | | | | |
| Mid-cut AE1S or | — | 0.4 | — | — | 0.4 | — | 1 | — |
| Coconut AE1S | | | | | | | | |
| Soap Powder | 4 | 6 | 10 | 5 | 25 | 15 | 6 | 30 |
| Dimethyl hydroxyethyl | — | 1 | — | — | — | 1 | — | — |
| lauryl ammonium | | | | | | | | |
| chloride | | | | | | | | |
| Non-Ionic (C12-14 EO7) | 1 | — | — | 1 | — | 0.6 | — | — |
| Zeolite | 0-5 | 0-5 | 0-5 | 0-5 | 0-5 | 0-5 | 0-5 | 0-5 |
| Carboxyl group- | 0.1 | 0.3 | 0.2 | 2.5 | 0.5 | 1 | 1.5 | 0.7 |
| containing polymer¹ | | | | | | | | |
| Acrylic acid/maleic | 1.0 | — | 0.5 | — | 0.5 | 0.5 | — | — |
| acid copolymer² | | | | | | | | |
| Protease (54.5 mg/g) | 0-1 | 0-1 | 0-1 | 0-1 | 0-1 | 0-1 | 0-1 | 0-1 |
| Amylase (29.26 mg/g) | 0-1 | 0-1 | 0-1 | 0-1 | 0-1 | 0-1 | 0-1 | 0-1 |
| Xyloglucanase | 0-1 | 0-1 | 0-1 | 0-1 | 0-1 | 0-1 | 0-1 | 0-1 |
| Polymeric dispersing or | 0-2 | 0-3 | 0-2 | 0-2 | 0-3 | 0-2 | 0-3 | 0-2 |
| soil release agent(s) | | | | | | | | |
| Bleach and bleach | 0-5 | 4-6 | 2-3 | 0-5 | 4-6 | 2-3 | 4-6 | 2-3 |
| activator | | | | | | | | |
| Silicate | 0-5 | 0-5 | 3-5 | 0-5 | 0-5 | 3-5 | 0-5 | 3-5 |
| Sodium Carbonate | 15-25 | 12-22 | 15-30 | 8-22 | 15-25 | 6-20 | 15-25 | 10-20 |
| Silicone Particle | — | 0.5 | — | — | — | 1 | — | — |
| Sodium Sulfate | balance | balance | balance | 30-70 | balance | balance | — | balance |
| Sodium Chloride | — | 20-40 | — | balance | — | — | balance | — |

¹HGLS 650 from Nippon Shokubai with monomers of AA/HAPS/PAB at a weight ratio of 80:15:5.
²A soap powder sourced from Ningbo Jiahe New Materials Technology Ltd. Co.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A spray-dried particulate composition comprising:
(a) from 0.1 wt % to 3 wt %, by weight of the composition, of a carboxyl group-containing polymer comprising:
(i) from 50 to 98 wt % structural units derived from one or more monomers comprising carboxyl groups;
(ii) from 1 to 49 wt % structural units derived from one or more monomers comprising sulfonate moieties; and
(iii) from 1 to 49 wt % structural units derived from one or more types of monomers selected from ether bond-containing monomers represented by formulas (I) and (II): 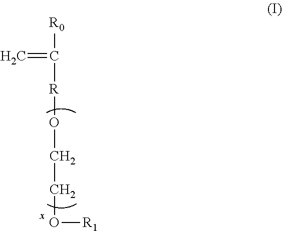
wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group; 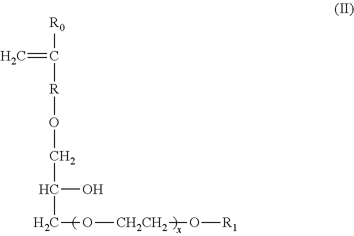
wherein in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group;
(b) from 3 wt % to 65 wt %, by weight of the composition, of linear alkyl benzene sulphonate; and
(c) from 3 wt % to 45 wt %, by weight of the composition, of soap powder.

2. The spray-dried particulate composition according to claim 1, wherein the carboxyl group-containing polymer comprising:
(i) from 68 to 97 wt % structural units derived from an acrylic acid-based monomer;
(ii) from 1 to 23 wt % structural units derived from a sulfonic acid group-containing monomer; and
(iii) from 1 to 20 wt % structural units derived from one or more types of monomers selected from ether bond-containing monomers represented by formulas (I) and (II).

3. The spray-dried particulate composition according to claim 1, wherein the carboxyl group-containing polymer comprises:
(i) the structure units as represented by formula (III): 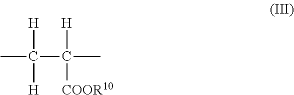
wherein R¹⁰ represents a hydrogen atom, a metal atom, an ammonium group, or an organic amine group;
(ii) the structure units derived from one or more monomers as represented by the formula (IV): 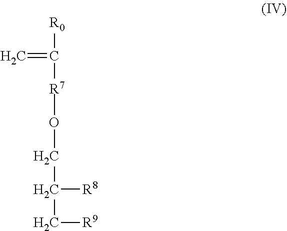
wherein R⁶ represents a hydrogen atom or a methyl group; R⁷ represents a CH₂ group, a CH₂CH₂ group, or a direct bond; R⁸ and R⁹ independently represent a hydroxyl group or —SO₃Z; Z represents a hydrogen atom, a metal atom, an ammonium group, or an organic amine group; and at least one of R⁸ and R⁹ is —SO₃Z; and
(iii) the structure units derived from one or more monomers as represented by the formula (II) wherein R⁰ is a hydrogen atom; R is a CH₂ group; x is 0; and R¹ is a C₁-C₄ alkyl group.

4. The spray-dried particulate composition according to claim 1, wherein the carboxyl group-containing polymer has a weight average molecular weight of from about 20,000 to 60,000.

5. The spray-dried particulate composition according to claim 1, wherein the composition comprises:
(a) from 0.1 wt % to 2.5 wt % by weight of the composition, of the carboxyl group-containing polymer;
(b) from 5 wt % to 60 wt % by weight of the composition, of linear alkyl benzene sulphonate; and
(c) from 4 wt % to 40 wt % by weight of the composition, of soap powder.

6. The spray-dried particulate composition according to claim 1, wherein the composition further comprises:
(d) from 0 wt % to 5 wt %, by weight of the composition, of zeolite builder; and/or
(e) from 0 wt % to 5 wt %, by weight of the composition, of phosphate builder; and/or
(f) from 0 wt % to 30 wt %, by weight of the composition, of sodium carbonate; and/or
(g) from 0 wt % to 70 wt %, by weight of the composition, of sodium sulfate; and/or
(h) from 0 wt % to 20 wt %, by weight of the composition, of silicate; and/or
(i) from 0% to 5% by weight of the composition, of a brightener.

7. The spray-dried particulate composition according to claim 1, wherein the soap powder comprises one or more C₁₀-C₂₂ fatty acids or alkali metal salts thereof.

8. The spray-dried particulate composition according to claim 1, wherein total surfactant content in the spray-dried particulate composition is from 10% to 80% by weight of the composition.

9. The spray-dried particulate composition according to claim 1, wherein the particulate composition is a solid free-flowing composition.

10. A laundry detergent product comprising the spray-dried particulate composition according to claim 1 and an additional ingredient, wherein the additional ingredient is selected from the group consisting of polymers, perfume, perfume encapsulates, surfactants, enzymes, bleach, bleach activators, phosphates, zeolite, silicates, carbonates, sodium chloride, chelants, hueing agents, dye transfer inhibitors, and any combinations thereof.

11. The laundry detergent product according to claim 10, wherein the additional ingredient is in a form of an agglomerates, a spray-dried powder, and/or an extruded powder.
